(19) United States
(12) Patent Application Publication
(10) Pub. No.: US 2016/0300573 A1
(43) Pub. Date: Oct. 13, 2016

(54) MAPPING INPUT TO FORM FIELDS

(71) Applicant: Google Inc., Mountain View, CA (US)

(72) Inventors: Victor Carbune, Zurich (CH); Daniel M. Keysers, Stallikon (CH); Thomas Deselaers, Zurich (CH)

(21) Appl. No.: 14/681,408

(22) Filed: Apr. 8, 2015

(51) Int. Cl. G10L 15/26; G10L 17/22

(52) U.S. Cl. CPC G10L 15/26; G10L 17/22

(57) ABSTRACT

In some implementations, user input is received while a form that includes text entry fields is being accessed. In one aspect, a process may include mapping user input to fields of a form and populating the fields of the form with the appropriate information. This process may allow a user to fill out a form using speech input, by generating a transcription of input speech, determining a field that best corresponds to each portion of the speech, and populating each field with the appropriate information.

### TECHNICAL FIELD

This disclosure generally relates to natural language processing, and one particular implementation relates to filling in electronic forms with data provided by a user, such as speech or textual input.

### BACKGROUND

Speech recognition includes processes for converting spoken words to text or other data. For example, a microphone may accept an analog signal, which is converted into a digital form that is then divided into smaller segments. The digital segments can be compared to the smallest elements of a spoken language, called phonemes. Based on this comparison, and an analysis of the context in which those sounds were uttered, the system is able to recognize the speech.

To this end, a typical speech recognition system may include an acoustic model, a language model, and a dictionary. Briefly, an acoustic model includes digital representations of individual sounds that are combinable to produce a collection of words, phrases, etc. A language model assigns a probability that a sequence of words will occur together in a particular sentence or phrase. A dictionary transforms sound sequences into words that can be understood by the language model.

One way in which speech recognition is used is to populate fields of an electronic form, using a speech input. Websites may provide forms for users to fill in, where the websites may be configured to perform actions based on the content of the received input.

### SUMMARY

In general, an aspect of the subject matter described in this specification may involve a process for mapping user input to fields of a form, and for populating the fields of the form with the appropriate information. This process may allow a user to more easily fill out a form using speech input, by generating a transcription of input speech, determining a field that best corresponds to each portion of the speech, and populating each field with the appropriate information.

For example, consider a form that includes multiple fields in which a user would enter information, such as the user's name, date of birth, and home address. Instead of requiring the user to select each field and enter the corresponding information in the selected field, the user may simply say, aloud and in no particular order, “Ryan Pond, 1203 Forty-Fifth Street New York, 8-5-1983.” In response to receiving the user's utterance, the system may, without any further input, determine that the “Ryan Pond” input corresponds to the “Name” field, the “8-5-1983” input corresponds to the “Date of Birth” field, and the “1203 Forty-Fifth Street New York” input corresponds to the “Address” field, and may automatically populate each field with its corresponding information. The updated form may be displayed for the user.

For situations in which the systems discussed here collect personal information about users, or may make use of personal information, the users may be provided with an opportunity to control whether programs or features collect personal information, e.g., information about a user's social network, social actions or activities, profession, a user's preferences, or a user's current location, or to control whether and/or how to receive content from the content server that may be more relevant to the user. In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained, such as to a city, zip code, or state level, so that a particular location of a user cannot be determined. Thus, the user may have control over how information is collected about him or her and used by a content server.

In some aspects, the subject matter described in this specification may be embodied in methods that may include the actions of presenting, at a user interface, a form that includes one or more text entry fields, wherein each text entry field is associated with a respective target data type, receiving a spoken input, and associating each of one or more of the text entry fields of the form with a different portion of a transcription of the spoken input.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

These other versions may each optionally include one or more of the following features. For instance, implementations may include updating, at the user interface, the form, wherein each of one or more of the text entry fields of the updated form includes a different portion of the transcription of the spoken input. In some implementations, the spoken input may include a first portion of spoken input followed by a second portion of spoken input. Some of these implementations may include updating, before receiving the second portion of spoken input and at the user interface, the form, wherein each of one or more of the text entry fields of the updated form includes a different portion of a transcription of the first portion of spoken input.

In some examples, receiving the spoken input and associating each of one or more of the text entry fields of the form with a different portion of the transcription may include receiving the first portion of spoken input, associating a particular text entry field of the form with a particular portion of a transcription of the first portion of spoken input, receiving the second portion of spoken input, and associating the particular text entry field of the form with a particular portion of a transcription of the first and second portions of spoken input in place of the particular portion of the transcription of the first portion of spoken input.

In some examples, receiving the spoken input and associating each of one or more of the text entry fields of the form with a different portion of the transcription may include receiving the first portion of spoken input, associating a first text entry field of the form with a particular portion of a transcription of the first portion of spoken input, receiving the second portion of spoken input, and associating each of one or more of the text entry fields of the form with a different portion of a transcription of the first and second portions of spoken input, comprising (i) associating a second text entry field of the form with a particular portion of a transcription of the first and second portions of spoken input that includes the particular portion of the transcription of the first portion of spoken input, and (ii) dissociating the first text entry field of the form and the particular portion of the transcription of the first portion of spoken input.

In some examples, receiving the spoken input and associating each of one or more of the text entry fields of the form with a different portion of the transcription may include receiving the first portion of spoken input, associating each of one or more of the text entry fields of the form with a different portion of a transcription of the first portion of spoken input such that the form includes a first set of text entry fields that are associated with transcribed text, receiving the second portion of spoken input, and associating each of one or more of the text entry fields of the form with a different portion of a transcription of the first and second portions of spoken input such that the form includes a second set of text entry fields that are associated with transcribed text, wherein a difference between the first set of text entry fields and the second set of text entry fields depends at least on (i) respective target data types associated with text entry fields of the form, (ii) the first portion of spoken input, and (iii) the first and second portions of spoken input.

One or more differences between the first set of text entry fields and the second set of text entry fields may further depend on data types associated with portions of the transcription of the first portion of spoken input and data types associated with portions of the transcription of the first and second portions of spoken input. Such differences between the first set of text entry fields and the second set of text entry fields may, for instance, include one or more of quantity and type of text entry fields that are associated with transcribed text.

In some implementations, associating each of one or more of the text entry fields of the form with a different portion of the transcription and updating, at the user interface, the form, may include associating each text entry field, of one or more of the text entry fields, with a different portion of the transcription that has been determined to correspond to the respective target data type with which the text entry field is associated. In some examples, the different portions of the transcription may at least include a first portion that includes a single textual term and a second portion that includes multiple textual terms.

In some aspects, the subject matter described in this specification may be embodied in methods that may include the actions of obtaining a form that includes one or more text entry fields that are each associated with a respective target data type, receiving an input including one or more words, generating multiple n-grams from the one or more words, selecting, from among the multiple n-grams generated from the one or more words, a particular n-gram for a particular text entry field based at least on the target data type associated with the particular text entry field, and populating the particular text entry field with the particular n-gram. The respective target data types associated with the text entry fields may also be inferred from context, for example, or other information that is not directly associated with the respective text entry fields. In this context, an n-gram may be a contiguous sequence of n items, such as phonemes, syllables, textual characters, and words. In some implementations, the processes described in association such these methods may be performed with an input including two or more words.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

These other versions may each optionally include one or more of the following features. For instance, implementations may include determining, based at least on the target data type associated with the particular text entry field, a mapping score that indicates a degree of confidence that the particular text entry field and one or more of the text entry fields that are different from the particular text entry field, are to be populated with the particular n-gram and one or more of the multiple n-grams that are different from the particular n-gram, respectively. In these implementations, selecting, from among the multiple n-grams generated from the one or more words, the particular n-gram for the particular text entry field based at least on the target data type associated with the particular text entry field, may include selecting, from among the multiple n-grams generated from the one or more words, the particular n-gram for the particular text entry field based at least on the mapping score.

Implementations may include selecting, from among the multiple n-grams generated from the one or more words, one of the n-grams that is different from the particular n-gram for one of the text entry fields that is different from the particular text entry field, based at least on the mapping score and populating the text entry field that is different from the particular text entry field with the n-gram that is different from the particular n-gram.

Implementations may include receiving user input that represents data provided by a user for populating the form and determining one or more transcription hypotheses for the user input, the one or more transcription hypotheses including one or more words. In these implementations, receiving the input including one or more words may include receiving the one or more transcription hypotheses.

In some implementations, generating multiple n-grams from the one or more words comprises may include generating one or more n-grams from each of the one or more transcription hypotheses. Furthermore, receiving user input that represents data provided by a user for populating the form may include receiving data that reflects an utterance of one or more words spoken by the user, and determining one or more transcription hypotheses for the user input, the one or more transcription hypotheses including one or more words may include determining one or more transcription hypotheses for the one or more words spoken by the user.

Implementations may include determining one or more confidence scores for each of one or more of the transcription hypotheses that each indicate a degree of confidence in one or more words of the respective transcription hypothesis correctly representing one or more of the words spoken by the user. In these implementations, selecting, from among the multiple n-grams generated from the one or more words, the particular n-gram for the particular text entry field based at least on the target data type associated with the particular text entry field, may include selecting, from among the multiple n-grams generated from the one or more words, the particular n-gram for the particular text entry field based at least on the target data type associated with the particular text entry field and one or more confidence scores associated with a particular transcription hypothesis from which the particular n-gram was generated.

Implementations may include determining the respective target data types associated with text entry fields of the form and accessing, based on the respective target data types associated with text entry fields of the form, one or more target data type models that indicate one or more of grammatical and lexical characteristics associated with words of the respective target data types. In some aspects, selecting, from among the multiple n-grams generated from the one or more words, the particular n-gram for the particular text entry field based at least on the target data type associated with the particular text entry field, may include selecting, from among the multiple n-grams generated from the one or more words, the particular n-gram for the particular text entry field based at least on one or more of grammatical and lexical characteristics associated with words of the target data type associated with the particular text entry field, and one or more of grammatical and lexical characteristics associated with the particular n-gram. In some implementations, the respective target data types may be inferred from context, for example, or other information that is not directly associated with the respective text entry fields.

In some implementations, determining the respective target data types associated with text entry fields of the form, may include determining the respective target data types associated with text entry fields of the form based at least on one or more labels included in the form that are associated with text entry fields of the form.

The details of one or more embodiments of the subject matter described in this specification are set forth in the accompanying drawings and the description below. Other potential features, aspects, and advantages of the subject matter will become apparent from the description, the drawings, and the claims.

### DESCRIPTION OF DRAWINGS

FIGS. 1 and 2 are conceptual diagrams of exemplary frameworks for mapping user input to fields of a form and populating the fields of the form with the appropriate information in a system.

FIG. 3 is a diagram of a system for mapping user input to fields of a form and populating the form with the appropriate information.

FIG. 4 is a flowchart of an example process of mapping user input to fields of a form and populating the fields of the form with the appropriate information.

FIG. 5 is a diagram of exemplary computing devices.

Like reference symbols in the various drawings indicate like elements.

### DETAILED DESCRIPTION

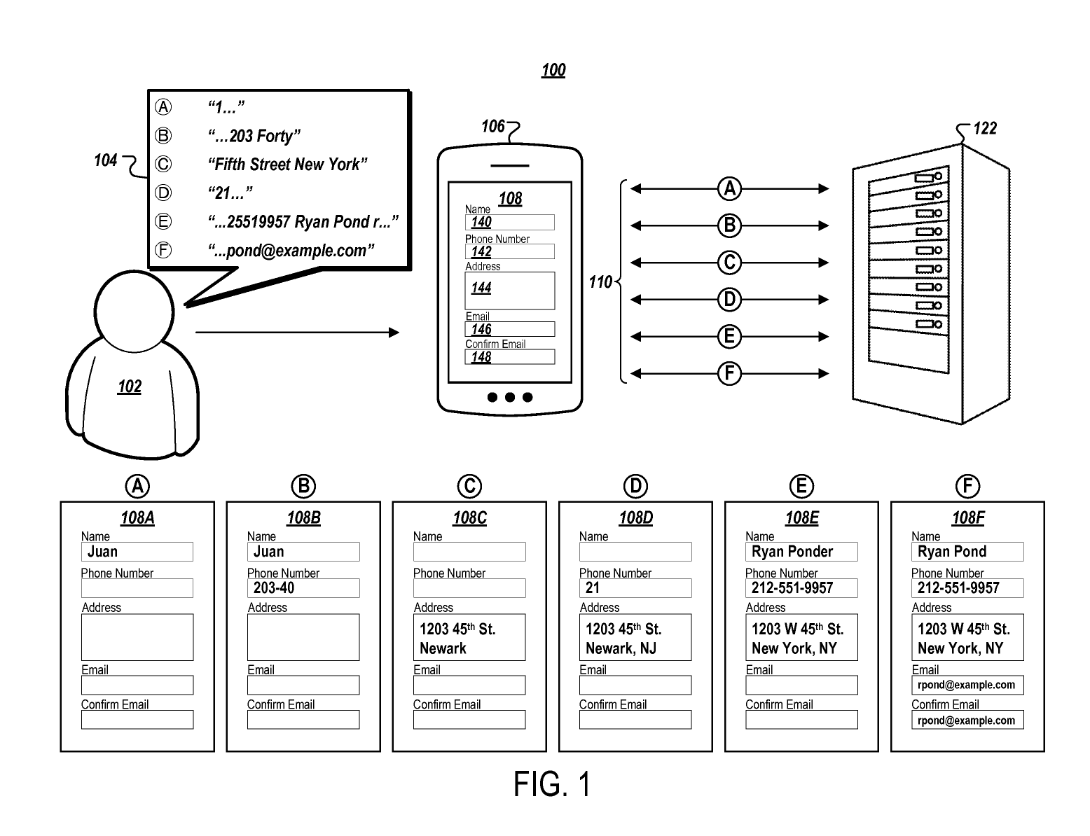

FIG. 1 is a conceptual diagram of an exemplary framework for mapping user input to fields of a form and populating the fields of the form with the appropriate information in a system 100. More particularly, the diagram depicts a user device 106 and a computing device 122, that collectively make up system 100. The diagram also depicts both a flow of data 110 between the user device 106 and the computing device 122, as well as a form 108 that is displayed by the user device 106 in various stages, labeled as form 108A to 108F, in time-sequenced stages “A” to “F,” respectively. Briefly, and as described in further detail below, the user device 106 may display form 108 which may receive utterance 104 from the user 102, and computing device 122 may generate a plurality of n-grams from a transcription of the 104, map n-grams to text entry fields 140-148, and may populate form 108 with the appropriate n-grams.

The user device 106 may be a mobile computing device, personal digital assistants, cellular telephones, smart-phones, laptop, desktop, workstation, and other computing devices. The user device 106 may display a form to the user 102. For example, the user device 106 may display a graphical user interface that includes form 108. A form may be a document that includes one or more labeled fields for the user to enter user input of a target data type. The target data type associated with each text entry field may correspond to a type or nature of data that each text enter field is intended to receive. For example, form 108 may include a name field 140 for a user to enter the user's name, a phone number field 142 for a user to enter the user's phone number, an address field 144 for a user to enter the user's address, an email field 146 for a user to enter the user's email address, and an email confirmation field 148 for a user to enter the user's email address. The fields may be text entry fields in which the user may enter text.

Upon accessing form 108, system 100 identifies the respective target data type associated with each text entry field 140-148. This identification process may be performed at computing device 122 or locally, at user device 106. For instance, field 140 may be identified as a field for receiving a user's name. This may be determined on the basis of labels provided proximate to each text entry field in form 108. For example, form 108 might include a “Name” text label proximate to field 140.

The user device 106 may receive an utterance of input words 104 spoken by user 102. For example, the user 102 might say “1203 Forty-Fifth Street New York 2125519957 Ryan Pond rpond@example.com.” As user 102 speaks, the user device 106 may, in real-time, record the user's utterance and provide the recorded audio data to computing device 122. The computing device 122 may obtain transcription hypotheses for the utterance in the audio data. For example, when audio data for the user's utterance is initially received by the computing device 122, e.g. as user 102 begins speaking, the computing device 122 may provide the audio data to a speech recognizer that produces a word lattice indicating multiple different combinations of words that may form different hypotheses for the recorded utterance. In some implementations, at least the transcription hypotheses may be obtained by the user device 106. In these implementations, network connectivity may not be necessary for user device 106 to perform steps described in association with FIG. 1.

The word lattice may include multiple nodes that correspond to possible boundaries between words. Each pair of nodes may have one or more paths that each correspond to a different sequence of words. For example, the computing device 122 may determine every appropriate transcription hypothesis for the recorded utterance by analyzing paths from a start node of the word lattice, e.g., corresponding to the point at which user 102 starts to speak, to an end node of the word lattice, e.g., corresponding to the point at which the most recent audio data is received. In some implementations, all transcription hypotheses are considered by system 100. In other implementations, they are not all considered. In these implementations, such transcription hypotheses obtained and/or considered may be those of a pruned search space. This may, for example, save computation time.

Additionally, the speech recognizer may indicate which of the words it considers most likely to be correct, for example, by providing confidence scores and/or rankings for both individual words and hypotheses. In this example, the word lattice may be updated when additional audio data is received from the user device 106. For instance, the additional audio data may cause the word lattice to expand to include additional nodes and words between nodes based on the additional audio data.

The computing device 122 can further determine the sequence of words in each hypothesis forming the path from the start node to the end node of the word lattice. The computing device 122 may generate, for each hypothesis, one or more hypothesis variants. Each hypothesis variant may include one or more n-grams generated from the sequence of words included in the original hypothesis. In this context, an n-gram is a contiguous sequence of n items, such as phonemes, syllables, textual characters, and words. For instance, generated n-grams may include one or more of phonemes, syllables, textual characters, and words included in the respective transcription hypothesis. In some implementations, the n-grams included in a hypothesis variant that includes a plurality of n-grams may be an n-gram sequence.

The n-grams included in each hypothesis variant may be variants of the words from the original hypothesis. For example, n-grams included in each hypothesis variants could be one or more of phrases or collections of these words, concatenations of these words and/or characters in these words, these words themselves, and segments of these words. In some implementations, the computing device 122 may determine hypothesis variants for each transcription hypothesis considered. Just as with the other processes described above, hypothesis variant generation processes may be performed for the user's utterance in real-time. That is, as hypotheses of the word lattice change with additional audio data, so do the hypothesis variants. In some implementations, all possible hypothesis variants are considered by system 100. In other implementations, they are not all considered. In these implementations, such hypothesis variants determined and/or considered may be those of a pruned search space. This may, for example, save computation time.

The computing device 122 may use the hypothesis variants to determine how the form 108 should be populated. Specifically, the computing device 122 may determine, for each hypothesis variant, the various ways that the form 108 could be populated with the n-grams of the hypothesis variant. In other words, the computing device 122 may consider various one-to-one mappings of hypothesis variant n-grams to text entry fields of form 108. The number of mappings considered may depend, at least in part, on the number of n-grams in the given hypothesis variant and the number of text entry fields included in the given form. In some implementations, all possible mappings are considered by system 100. In other implementations, they are not all considered. In these implementations, such mappings evaluated may be those of a pruned search space. This may, for example, save computation time.

For each mapping considered, the computing device 122 may determine a mapping score that indicates a degree of confidence that the form would be filled out correctly if its text entry fields were populated with the n-grams of the hypothesis variant according to the mapping, e.g., how well each n-gram pairs with the text entry field that each n-gram is mapped to. That is, the mapping score for a given mapping reflects the likelihood that the n-grams represent data that user 102 intends to provide to the text entry fields that each n-gram has been paired with under the mapping.

The mapping score for each mapping may be a based on one or more levels of correspondence between the n-grams of the hypothesis variant and the text entry fields to which each n-gram has been mapped, respectively. In some implementations, the computing device 122 may determine a relevancy score for each n-gram to text entry field pair of the mapping.

The relevancy score for a given pair may be based at least on the target data type for the pair's text entry field, confidence scores and/or rankings provided for the words from which the pair's n-gram was generated, relevancy scores for other n-grams of the hypothesis variant, an estimated data type of the n-gram, samples of forms that have already been populated by the user and/or others, a level of correspondence between the position of the n-gram in an n-gram sequence of the hypothesis variant and the position of the text entry field within the form 108, user information, and information retrieved from one or more search domains. The computing device 122 may determine the mapping score based on the one or more relevancy scores determined for the one or more n-gram to text entry field pairs of the mapping.

For instance, the mapping score may be an average of the relevancy scores determined for the given mapping. In some implementations, the mapping score may be a weighted average of its relevancy scores. For example, relevancy scores for pairs of n-grams and text entry fields may be weighted according to an estimated importance of the n-gram, e.g., number of characters in an n-gram with respect to the length of the hypothesis variant, and/or a level of estimated importance of the text entry field, e.g., based on whether population of the text entry field is optional or not. Furthermore, different weights may be assigned to the parameters of that the mapping score is based on, as described above.

In some implementations, the computing device 122 may utilize a machine learning system to determine mapping scores. For instance, the machine learning system may be trained, based on populated form samples, labeled form samples, and user information, to recognize when n-grams are of the target data type of the text entry fields that they are paired with. That is, machine learning techniques may also be utilized to more accurately identify the target data types of the various text entry fields. The machine learning system may be able to learn how the user typically fills out forms and tailor the mapping scoring scheme to reflect their habits. In some implementations, machine learning techniques may be used to determine confidence scores and/or rankings for both individual words and hypotheses of the word lattice. In some implementations, user device 106 may utilize a machine learning system, such as that described in association with computing device 122, to determine such mapping scores. In these implementations, network connectivity may not be necessary for user device 106 to perform steps described in association with FIG. 1.

Once the computing device 122 has determined the mapping score for each mapping between a hypothesis variant and the form 108 that is to be considered, and has done so for every hypothesis variant generated for every transcription hypothesis, the computing device 122 may select a particular mapping and populate the form 108 accordingly. The computing device 122 may select a mapping based on mapping score. In some implementations, the computing device 122 may select the mapping that has the highest mapping score at the given time. In some implementations, such mapping selections may be performed by user device 106. In these implementations, network connectivity may not be necessary for user device 106 to perform steps described in association with FIG. 1.

The computing device 122 may populate text entry fields of the form 108 according to the selected mapping. Text entry fields may be populated in real-time, e.g., as the user 102 speaks, or may be populated when the user 102 has finished speaking. In implementations where user device 106 performs the steps described in association with FIG. 1, such text entry field population processes may be performed locally by user device 106. In these implementations, the form 108 may be updated in concurrence with or immediately following obtaining or receiving information to associate text entry fields with transcription portions. In other implementations, the form 108 may be updated once it has been determined that the user has finished providing input. In these implementations, processes of associating text entry fields with transcription portions may still be executed in real-time. In some examples, the form 108 may be periodically updated. In these examples, user device 106 may periodically update form 108 according to current associations between text entry fields and transcription portions. That is, the associations between text entry fields and transcription portions resulting from such associating processes may, in some implementations, be apparent in the form 108 as displayed. In some examples, processes of associating text entry fields with transcription portions may also be executed periodically.

In some implementations, the computing device 122 may modify a mapping. This may include replacing information included in the n-gram or augmenting such an n-gram with additional information. For instance, the computing device 122 may determine that a text entry field may require more information than the user 102 has provided, generate the additional information required, and augment an n-gram of the mapping with the additional information. The computing device 122 may also provide this additional information with an autocomplete function. In these implementations, the computing device 122 may populate the corresponding text entry field with the n-grams of the modified mapping. In implementations where user device 106 performs the steps described in association with FIG. 1, such modifications may be performed locally by user device 106.

The computing device 122 may provide user device 106 with updated information for the form 108. In implementations where the text entry fields are populated in real-time, this feature may enable the user 102 to watch the form 108 become populated with their information as or shortly after they speak. In these implementations, the state of the form 108 at a given point in time is representative of the selected mapping of n-grams to text entry fields for the audio data received up to that point in time. In implementations where user device 106 performs the steps described in association with FIG. 1, user device 106 may directly provide updated information for the form 108. In these implementations, the form 108 may be updated in concurrence with or immediately following obtaining or receiving information to associate text entry fields with transcription portions. In other implementations, the form 108 may be updated once it has been determined that the user has finished providing input. In these implementations, processes of associating text entry fields with transcription portions may still be executed in real-time. In some examples, the form 108 may be periodically updated. In these examples, user device 106 may periodically update form 108 according to current associations between text entry fields and transcription portions. That is, the associations between text entry fields and transcription portions resulting from such associating processes may, in some implementations, be apparent in the form 108 as displayed. In some examples, processes of associating text entry fields with transcription portions may also be executed periodically.

In the example of FIG. 1, the user 102 has accessed form 108 and the computing device 122 has identified the respective target data type associated with each text entry field 140-148. Stage A is representative of the point at which user 102 begins to say the phrase: “1203 Forty-Fifth Street New York 2125519957 Ryan Pond rpond@example.com.” More specifically, the user 102 says “1,” and the user device 106 records the utterance of the user 102. The user device 106 transmits audio data that includes the user's utterance to the computing device 122 over a network.

The computing device 122 may generate multiple transcription hypotheses for the utterance. Each hypothesis generated may be, as described above, included as a path within a word lattice generated based on the audio data received in stage A. The computing device 122 may further generate one or more hypothesis variants. For example, the hypothesis variants may include (i) “1,” and (ii) “Juan.” That is, “1” and “Juan” are both n-grams generated from one or more words included in a respective hypothesis.

The computing device 122 may (i) determine a mapping score for every appropriate mapping between “1” and form 108, and (ii) determine a mapping score for every appropriate mapping between “Juan” and form 108. For example, the computing device 122 may generate a mapping score for “1” and name field 140, a mapping score for “1” and phone number field 142, a mapping score for “1” and address field 144, a mapping score for “1” and email field 146, and a mapping score for “1” and email confirmation field 148. The computing device 122 will also determine mapping scores for “Juan,” and other hypothesis variants, under this same scheme.

The computing device 122 may determine, based on mapping scores, which hypothesis variant n-gram to text entry field mapping for the form 108 should be selected. In this example, the computing device 122 may determine that, for the received utterance, the greatest mapping score corresponds to a mapping of “Juan” and name field 140. Since the level of correspondence between the position of the “Juan” n-gram within the hypothesis variant, e.g., first, and the position of name field 140 within the form 108, e.g., first, is high, the mapping score for the “Juan” n-gram and text entry field 140 may have been relatively higher than others, as positively influenced by this level of correspondence.

If the computing device 122 were to consider “Juan” to most likely be a name, the mapping score for “Juan” and name field 140 will be positively influenced, e.g., because the computing device 122 has identified “name” as the target data type for name field 140. For at least these reasons, “Juan” and name field 140 may yield the greatest mapping score. With this, the computing device 122 may populate name field 140 with “Juan,” and provide an updated form 108A to user device 106 for display. In some implementations, user device 106 receives information to associate name field 140 of form 108 with “Juan.” For example, such information may include one or more of information indicating mapping determination results, instructions indicating how the form 108 is to be populated, an update for the form 108, and an updated version of the form 108. The user device 106 may, for instance, update the form being displayed such that name field 140 includes “Juan,” such as that an updated form 108A is displayed.

By stage B of FIG. 1, the user 102 has said “1203 Forty.” The user device 106 transmits audio data of this utterance to the computing device 122 over a network.

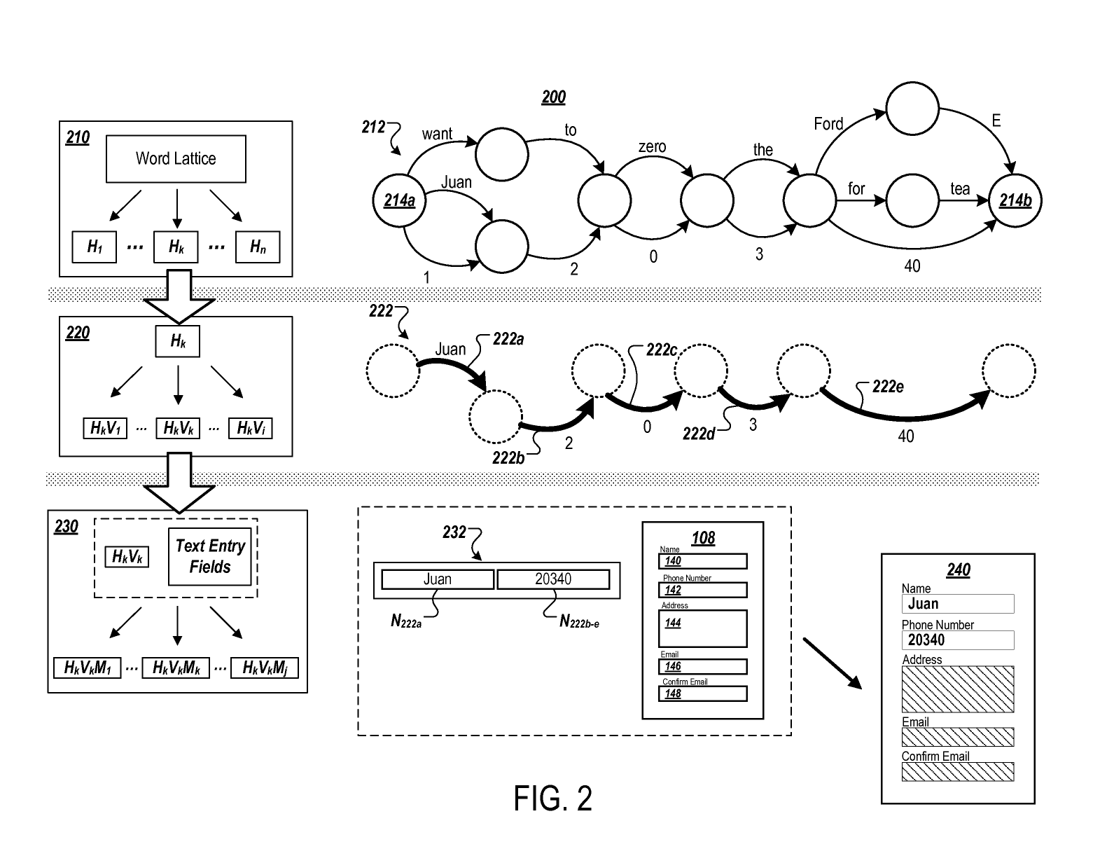

FIG. 2 is a conceptual diagram of an exemplary framework 200 for mapping user input to fields of a form and populating the fields of the form with the appropriate information in system 100 at stage B as described in association with FIG. 1. In some implementations, the processes described in association with FIG. 2 may be performed at least in part by computing device 122. In these implementations, processes described in association with FIGS. 1 and 2 may also be handled or performed by other cloud computing devices that are communicatively coupled with one or more of user device 106 and computing device 122. In other implementations, the processes described in association with FIG. 2 may be performed in part or entirely by user device 106. In these implementations, network connectivity may not be necessary for user device 106 to perform steps described in association with FIGS. 1 and 2.

Referring again to FIG. 1, the computing device 122 may generate multiple transcription hypotheses for the utterance. This may include, for example, the computing device 122 updating a word lattice, e.g., produced in stage A for a first portion of spoken input, with audio data received for stage B. Such a word lattice updated in stage B would include words for the audio data received in stages A through B, e.g., for first and second portions of spoken input. As described above, the computing device 122 may determine every appropriate transcription hypothesis for the entirety of the recorded utterance, which may form each of at least some of the paths that can be taken from the start node to the end node, e.g., stage A through stage B, of the word lattice.

FIG. 2 includes a model 210 that generally depicts the relationship between a word lattice and hypotheses that it yields, e.g., H₁ to Hₙ. For example, the updated word lattice at stage B may be the word lattice 212. The word lattice 212 includes a start node 214a and an end node 214b. The sequence of words presented by each path from 214a to 214b reflects each appropriate transcription hypothesis yielded by word lattice 212. The word lattice at stage B may yield hypotheses H₁ to Hₙ, where n is less than or equal to the total number paths from 214a to 214b.

The computing device 122 generates one or more hypothesis variants for each transcription hypothesis for the recorded utterance. FIG. 2 includes a model 220 that generally depicts the relationship between an exemplary hypothesis, e.g., Hₖ, and hypothesis variants, e.g., HₖV₁ to HₖV₁. For stage B, an exemplary hypothesis 222 is yielded by word lattice 212. Words 222a-e, e.g., “Juan,” “2,” “0,” “3,” “40”, form the path taken by hypothesis 222 from start node 214a to end node 214b of word lattice 212. Other hypotheses enabled by word lattice 212 may include, for example, (i) “want,” “to,” “zero,” “the,” “Ford,” “E,” and (ii) “1,” “2,” “zero,” “3,” “for,” “tea.”

The hypothesis variants generated by computing device 122 for hypothesis 222 may each include an n-gram or sequence of n-grams generated from words 222a-e. Each n-gram included in such a hypothesis variant may be any of words 222a-e, a phrase formed by any of words 222a-e, a concatenation of any of words 222a-e or characters of words 222a-e, segments of any of words 222a-e, and combinations thereof.

The computing device 122 may consider various one-to-one mapping of hypothesis variant n-grams to text entry fields of form 108. For each mapping considered, the computing device 122 may determine a mapping score that indicates a degree of confidence that the form would be filled out correctly if its text entry fields were populated with the n-grams of the hypothesis variant according to the mapping, e.g., how well each n-gram pairs with the text entry field that it is mapped to.

FIG. 2 includes a model 230 that generally depicts the relationship between an exemplary hypothesis variant, e.g., HₖVₖ, text entry fields of a form, and various possible mappings for exemplary hypothesis variant HₖVₖ and the text entry fields of the form, e.g., HₖVₖM₁ to HₖVₖMⱼ, each of which have a corresponding mapping score. For stage B, an exemplary hypothesis variant 232 is generated from hypothesis 222. For example, hypothesis variant 232 may include an n-gram sequence that includes n-gram N₂₂₂ₐ and n-gram N_{222b-e}. In this example, the first n-gram in the n-gram sequence of hypothesis variant 232, n-gram N₂₂₂ₐ, is simply the word 222a, e.g., “Juan”. The second n-gram in the n-gram sequence of hypothesis variant 232, n-gram N_{222b-e}, is a concatenation of words 222b, e.g., “2”, 222c, e.g., “0”, 222d, e.g., “3”, and 222e, e.g., “40”.

Each mapping of hypothesis variant 232 and form 108 considered by computing device 122 may correspond to “Juan” being mapped to one of text entry fields 140-148 and “20340” being mapped to another, different one or text entry fields 140-148. The computing device 122 may go through each of various mappings for a hypothesis variant and determine each corresponding mapping score. This may be performed for every hypothesis variant of every hypothesis developed for the utterance. The computing device 122 may determine, based at least on the mapping scores, which one of the generated hypothesis variants most suitably maps to text entry fields of the form 108 and the preferred mapping, or how the form 108 should be populated with the n-grams included in this sequence, i.e., which text entry fields are paired with which n-grams.

In this example, the computing device 122 may determine that the hypothesis variant 232 most suitably maps to text entry fields of the form 108 and further that the selected mapping includes populating name field 140 with the “Juan” n-gram, i.e., n-gram N₂₂₂ₐ, and populating the phone number field 142 with the “20340” n-gram, i.e., n-gram N_{222b-e}. FIG. 2 depicts this mapping as mapping 240. The mapping score for this particular mapping of hypothesis variant 232 to form 108 may be positively influenced by the levels of correspondence between the first n-gram in the n-gram sequence, i.e., “Juan”, and the first text entry field in the form 108, i.e., name field 140, in a manner similar to that described in reference to stage A.

Similarly, a relevancy score for “20340” and the phone number field 142, e.g., that the mapping score is based on, may also reflect a relatively high level of correspondence. In determining a relevancy score for this particular n-gram to text entry field pair, i.e., “20340” to phone number field 142, the computing device 122 may consider “20340” to most likely be the first five digits of a phone number.

First, there is a clear correspondence between the position of “20340” within the hypothesis variant 232 and the position of the phone number field 142 within the form 108. Beyond the position correspondence, the computing device 122 may have determined from information retrieved from a search domain that “203” is a Connecticut telephone area code that is relatively common. For at least these reasons, the mapping score for the selected mapping may have been relatively higher than others generated. The computing device 122 may further augment the “20340” n-gram with additional information to further conform to the target data type of the phone number field 142. For instance, this particular n-gram may be augmented with a hyphen between the third and fourth digits, e.g., “203-40”, to better reflect that the n-gram is the first five digits of a phone number. The computing device 122 may populate phone number field 142 with the “203-40” modified n-gram and retain “Juan” as the n-gram with which to populate name field 140, and provide the updated form 108B to user device 106. In some implementations, user device 106 receives information to associate phone number field 142 of form 108 with “203-40.” The user device 106 may, for instance, update form 108A to 108B for display.

By stage C of FIG. 1, the user 102 has said “1203 Forty Fifth Street New York.” The user device 106 transmits audio data of this utterance to the computing device 122 over a network. The computing device 122 may generate multiple transcription hypotheses for the utterance. This may include, for example, the computing device 122 updating a word lattice with audio data received for stage C. Such a word lattice updated in stage C would include transcription hypotheses for the audio data received in stages A through C.

As described above, the computing device 122 may determine every hypothesis for the entirety of the recorded utterance, which may form each of various paths that can be taken from the start node to the end node, e.g., stage A through stage C, of the word lattice. Hypothesis variants may be generated for each hypothesis, in a manner similar to that which has been described above, and utilized to determine a suitable mapping of n-grams to text entry fields for stage C.

In this example, the computing device 122 determines that a preferable mapping includes populating address field 144 with “1203 forty fifth street Newark.” This means that the mapping that has been selected corresponds to a hypothesis variant including a single n-gram of “1203 forty fifth street Newark,” which could be a phrase of words including words found in the original hypothesis as well as a concatenation of characters and/or words found in the original hypothesis, e.g., “1203”. That is, the computing device 122 determines that there is a relatively high likelihood that this particular n-gram is an address, which is the target data type determined for address field 144. Although the correspondence between the positions of the n-gram and text entry field, the correspondence between their data types is significant enough to yield a high relevancy score in stage C.

The word lattice, as updated in stage C, may have included both “Newark” and “New York” at a same point between the start node and end node of the word lattice. In this example, characteristics of the utterance provided to the speech recognizer may have indicated that the user 102 most likely said “Newark.” That is, a confidence score provided in the word lattice for “Newark” may have been higher than that a confidence score for “New York.” In this regard, hypothesis variants that include “Newark” may be favorable to those that include “New York.”

Prior to populating the form 108, the computing device 122 may modify the “1203 forty fifth street Newark” n-gram. For instance, it may be determined to modify “forty fifth street” to read “45^{th} St.” This modification may be performed in order to better conform to an address format and/or minimize the number of characters provided to the address field 144. In some implementations, the computing device 122 may identify character limits within text entry fields and therefore modify n-grams such that character limits are met. Such modifications may include abbreviations. The computing device 122 may provide updated form 108C to the user device 106 for display. In some implementations, user device 106 receives information to associate text entry fields 140-148 of form 108's with transcription portions, e.g., transcribed text, of input 104. In this example, the information to associate text entry fields 140-148 of form 108's with transcription portions may be received by user device 106 that dissociates name field 140 of form 108 and “Juan,” dissociates phone number field 142 of form 108 and “203-40,” and associates address field 144 of form 108 with “1203 45^{th} St. Newark.” The user device 106 may, for instance, update form 108B to form 108C for display. Such associations are at least evident in the depictions of 108B and 108C.

By stage D of FIG. 1, the user 102 has said “1203 Forty Fifth Street New York 21.” The user device 106 transmits audio data of this utterance to the computing device 122 over a network. The computing device 122 may generate multiple transcription hypotheses for the utterance. This may include, for example, the computing device 122 updating a word lattice with audio data received for stage D. Such a word lattice updated in stage D would include candidate transcriptions for the audio data received in stages A through D.

As described above, the computing device 122 may determine every hypothesis for the entirety of the recorded utterance, which may form each of various paths that can be taken from the start node to the end node, e.g., stage A through stage D, of the word lattice. Hypothesis variants may be generated for each hypothesis, in a manner similar to that which has been described above, and utilized to select a mapping of n-grams to text entry fields for stage D.

In this example, the computing device 122 determines that a preferable mapping includes populating address field 144 with “1203 forty fifth street Newark” and populating phone number field 142 with “21.” In addition to modifications described above, the “1203 forty fifth street Newark” may be modified to not only read “1204 45^{th} St. Newark,” but to further read “1204 45th St. Newark, N.J.”

Upon reception of the “21” audio data at stage C, the computing device 122 may have determined that the user 102 had moved on from providing the address to provide, for instance, a phone number. If, for example, the computing device 122 was expecting to provide a state at the end of the address, the address n-gram may have been modified to include the most likely state. The computing device 122 may have utilized information from a search domain to determine that the state associated with “Newark” is most likely New Jersey, or “NJ.” The computing device 122 may provide updated form 108D to the user device 106 for display. In some implementations, user device 106 receives information to associate phone number field 142 of form 108 with “21.” The user device 106 may, for instance, update form 108C to form 108D for display. As described above and illustrated in FIG. 1, the text entry fields 140-148 of form 108's association with transcription portions, e.g., transcribed text, of input 104, may be modified at each stage or as additional user input is received and/or processed.

By stage E of FIG. 1, the user 102 has said “1203 Forty Fifth Street New York 2125519957 Ryan Pond r.” The user device 106 transmits audio data of this utterance to the computing device 122 over a network. The computing device 122 may generate multiple transcription hypotheses for the utterance. This may include, for example, the computing device 122 updating a word lattice with audio data received for stage E. Such a word lattice updated in stage E would include candidate transcriptions for the audio data received in stages A through E.

As described above, the computing device 122 may determine every hypothesis for the entirety of the recorded utterance, which may form each of various paths that can be taken from the start node to the end node, e.g., stage A through stage E, of the word lattice. Hypothesis variants may then be generated for each hypothesis, in a manner similar to that which has been described above, and utilized to select a mapping of n-grams to text entry fields for stage E.

In this example, the computing device 122 determines that a preferable mapping includes populating address field 144 with “1203 forty fifth street New York,” populating phone number field 142 with “2125519957,” and populating name field 140 with “Ryan Ponder.” Upon reception of “25519957,” the computing device may have determined that “2125519957” is most likely a phone number. Accordingly, mapping scores for mappings that include this n-gram being paired with phone number field 142 would have benefited from this correspondence.

If, for instance, the computing device 122 is able to determine that “2125519957” is most likely a phone number, and further that the area code for this phone number is a Manhattan area code, e.g., “212” is a common area code for Manhattan, New York, N.Y., then mapping scores for hypothesis variants generated from “New York,” instead of “Newark,” may rise. That is, the computing device 122 may determine that it is likely that the address and phone number provided correspond to a same region. For this reason, the mapping selected may include populating address field 142 with an n-gram of “1203 forty fifth street New York.” The address n-gram may be modified in a manner similar to that which has been described above, and may be further modified to indicate that the address is located in west Manhattan, e.g., “1203 45^{th} St.”

In this example, characteristics of the utterance provided to the speech recognizer may have indicated that the user 102 most likely said “Ponder” instead of “Pond” followed by “r.” For this reason, the mapping score for selected mapping may have been favorably influenced by confidence scores and/or rankings associated with “Ponder” in the word lattice. The computing device 122 may provide updated form 108E to the user device 106 for display. In some implementations, user device 106 receives information to modify the text entry fields 140-148 of form 108's association with transcription portions, e.g., transcribed text, of input 104. The user device 106 may, for instance, update form 108D to form 108E for display.

By stage F of FIG. 1, the user 102 has said “1203 Forty Fifth Street New York 2125519957 Ryan Pond rpond@example.com.” The user device 106 transmits audio data of this utterance to the computing device 122 over a network. The computing device 122 may generate multiple transcription hypotheses for the utterance. This may include, for example, the computing device 122 updating a word lattice with audio data received for stage F. Such a word lattice updated in stage F would include candidate transcriptions for the audio data received in stages A through F.

As described above, the computing device 122 may determine every hypothesis for the entirety of the recorded utterance, which may form each of various paths that can be taken from the start node to the end node, e.g., stage A through stage F, of the word lattice. Hypothesis variants may be generated for each hypothesis, in a manner similar to that which has been described above, and utilized to select a mapping of n-grams to text entry fields for stage F.

In this example, the computing device 122 may have determined that email field 146 and email confirmation field 148 have exactly the same target data type. In this situation, the computing device 122 may treat fields 146 and 148 as if they are a single field. Accordingly, a same n-gram is to be mapped to these fields. The computing device 122 may, for instance, determine based on user information that “rpond@example.com” suitably maps to fields 146 and 148. In some implementations, the mappings considered by computing device 122 include mappings where a single n-gram of the hypothesis variant is mapped to multiple text entry fields of form 108, e.g., an n-to-m mapping.

For example, user 102 may have previously provided “rpond@example.com” to an email text entry field of another form displayed on user device 106. Through the use of machine learning techniques, the computing device 122 may determine that “rpond@example.com” is most likely the user's email address. It follows that the computing device 122 may determine that the last name of “Pond” more suitably maps to name field 140 than “Ponder” does, since the “r” received following “Pond” is most likely part of an email address. The computing device 122 may provide updated form 108F to the user device 106 for display. In some implementations, user device 106 receives information to modify the text entry fields 140-148 of form 108's association with transcription portions, e.g., transcribed text, of input 104. The user device 106 may, for instance, update form 108E to form 108F for display.

Although the processes of FIGS. 1 and 2 have been described in association with speech input, these processes may be adapted to map input such as speech, keyboard entry, handwriting, and gestures to fields of a form. In some implementations, the processes as described in association with FIGS. 1 and 2 above may be performed entirely by a single device, such as user device 106, computing device 122, and other cloud computing devices.

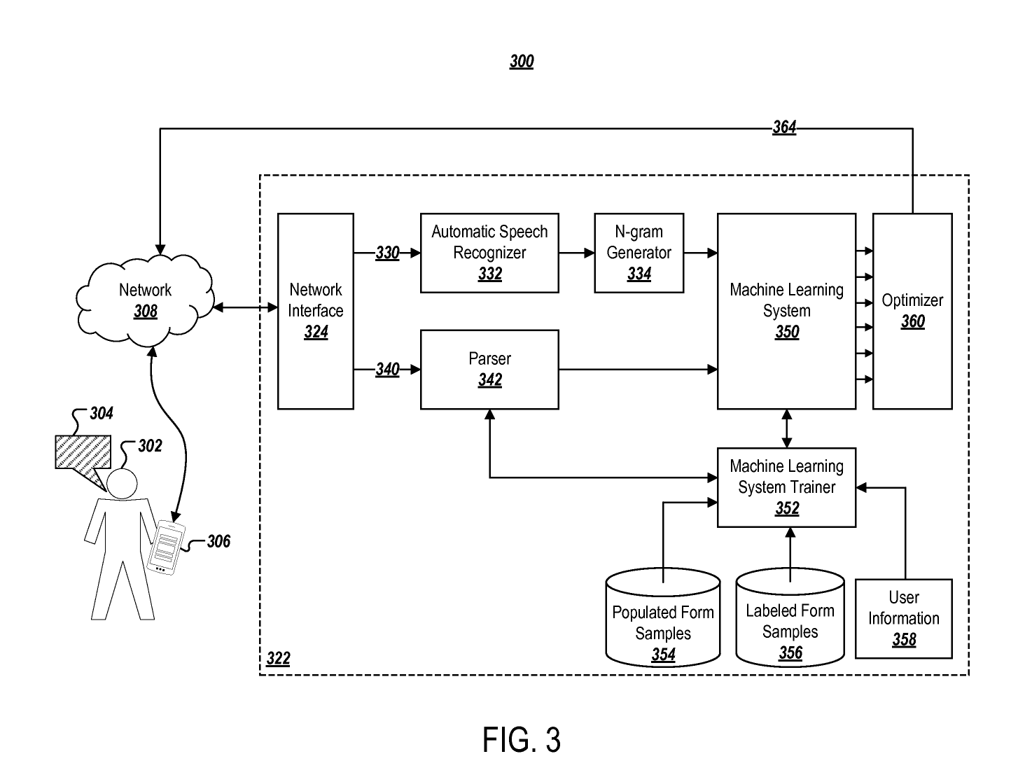

FIG. 3 depicts an exemplary system 300 for mapping user input to fields of a form and populating the fields of the form with appropriate information. More particularly, FIG. 3 depicts a user 302 who may provide input 304 to a user device 306. The user 302 may further access a digital form on the user device 306. User device 306 may communicate with a computing device 322 over a network 308. Similar to that which has been described in reference to FIGS. 1 and 2 above, user device 306 may provide information associated with input 304 and information about a digital form accessed to computing device 322. The computing device 322 may receive this information over network 308 and provide user device 306 with an updated digital form 364 that has been populated in accordance with the selected mapping. In some implementations, the functions of computing device 322, as described in association with FIG. 3, may be performed by user device 306 and/or other cloud computing devices. In some implementations, the processes described in association with FIG. 3 may be performed at least in part by computing device 322. In these implementations, processes described in association with FIG. 3 may also be handled or performed by other cloud computing devices that are communicatively coupled with one or more of user device 106 and computing device 122. In other implementations, the processes described in association with FIG. 3 may be performed in part or entirely by user device 306. In these implementations, network connectivity may not be necessary for user device 306 to perform steps described in association with FIG. 3. For instance, user device 306 may perform the all of the operations described in association with FIG. 3 locally.

The computing device 322 may receive information over network 308 through the use of a network interface 324, which may provide input information 330 to an automatic speech recognizer 332 and information about the digital form 340 to a parser 342. Input information 330 may indicate at least a portion of input 304, for example, as audio data for a recorded utterance produced by user 302. Information about the digital form 340 may be information associated with the digital form being accessed by user 302 on user device 306. This information may allow computing device 322 to determine features of the digital form, as well as obtain the digital form itself. For instance, this information may include the text included in the digital form, the layout of the digital form, the fields of the digital form, source code for the digital form, e.g., HTML, text formatting properties of the digital form, and/or a URL of the digital form.

Automatic speech recognizer 332 may receive input information 330 and obtain acoustic features representing the user's utterance of input 304. Acoustic features may be mel-frequency cepstrum coefficients (MFCCs), linear prediction coefficients (LPGs), or some other audio representation. In some implementations, the automatic speech recognizer 332 may develop a word lattice for the utterance based on input information 330 and/or the acoustic features it has extracted from input information 330. The automatic speech recognizer 332 may further identify boundaries between one or more of words, syllables, and phonemes.

Similar to that which has been described above in reference to FIGS. 1 and 2, the word lattice developed by computing device 322 may include one or more nodes that correspond to possible boundaries between words. Such a word lattice also includes multiple links from node-to-node for the possible words within appropriate transcription hypotheses that result from the word lattice. A given transcription hypothesis is formed by a sequence of links along a specific path from a start node to an end node of the word lattice. In addition, each of these links can have one or more confidence scores of that link being the correct link from the corresponding node. The confidence scores are determined by the automatic speech recognizer module 332 and can be based on, for example, a confidence in the match between the speech data and the word for that link and how well the word fits grammatically and/or lexically with other words in the word lattice.

The word lattice may be processed by n-gram generator 334. In some implementations, the n-gram generator 334 may act to generate hypothesis variants for every transcription hypothesis provided in the word lattice developed by automatic speech recognizer 332. Each hypothesis variant generated by n-gram generator 334 may include one or more n-grams generated from the sequence of words included in the original hypothesis. In some implementations, the n-grams included in a hypothesis variant that includes a plurality of n-grams may be an n-gram sequence. The n-grams included in each hypothesis variant may be variants of the words from the original hypothesis. For example, n-grams included each hypothesis variants could be one or more of phrases or collections of these words, concatenations of these words and/or characters in these words, these words themselves, and segments of these words.

In some implementations, the n-gram generator 334 may determine various hypothesis variants for every appropriate transcription hypothesis. Both the word lattice provided by the automatic speech recognizer and the hypothesis variants generated by n-gram generator, may be developed, updated, and maintained by automatic speech recognizer 332 and n-gram generator 334, respectively, in real-time. That is, automatic speech recognizer 332 and n-gram generator 334 may adjust their respective outputs as user 302 provides additional input 304 to user device 306.

Parser 342 may receive information about the digital form 340 and parse text included within the digital form. For instance, parser 342 may be able to process the text included in the digital form in order to identify labels of text entry fields that may be utilized to identify the target data type of the text entry fields. Text included in the digital form may be parsed with a finite-state-machine-based pattern matching system to determine an extent that the text matches different grammars for, for example, an address target data type, a birth date target data type, a credit card number target data type, and so on.

Machine learning system 350 may receive information from n-gram generator 334 and parser 342 to identify target data types for each field included in the digital form, as well as develop mapping scores in a manner similar to that which has been described above in reference to FIGS. 1 and 2. The machine learning system 350 may be trained by machine learning system trainer 352 using data from parser 342, populated form samples 354, labeled form samples 356, and user information 358. The machine learning system trainer 352 may be integral to the machine learning system 350 or may implemented with one or more cloud computing devices.

Populated for samples 354, e.g., forms that have already been populated by user 302 and/or other users, and labeled form samples 356, e.g., forms with labeled text entry fields with known target data types, may be utilized by machine learning trainer 352 to train machine learning system 350 to identify target data types of each text entry field in the digital form and determine a degree to which each n-gram corresponds to the target data types of the digital form. The target data type of a text entry field of a form indicates the type of data that the respective text entry field is intended to receive.

Within a digital form, the target data type of each text entry field may be reflected by their respective labels. The machine learning system trainer 352 may train the machine learning system 350 to simply identify the target data type of each text entry field of the digital form by its respective label. For example, machine learning system trainer 352 may train machine learning system 350 to recognize that a text entry field labeled “Name” is most likely intended to a user's first name and possibly last name. Target data type identification may be performed by computing device 322 when it initially accesses the digital form. In some implementations, the respective target data types may be inferred from context, for example, or other information that is not directly associated with the respective text entry fields. For instance, one or more target data types of the text entry fields may be inferred based at least in part on the type of form to which they belong. In some examples, characteristics of the source of a form, e.g., website, may be considered to infer data types included in the form.

The machine learning system trainer 352 may develop one or more target data type models and train machine learning system 350 with the one or more models. For example, the one or more target data type models may define grammatical and/or lexical characteristics for n-grams of each target data type. The machine learning system trainer 352 may create and update the target data type models and use them to train the machine learning system 350 to more accurately populate digital forms. The target data type models may be created and updated by the machine learning system trainer 352 based on populated form samples 354, labeled form samples 356, and/or user information 358.

For instance, these models may be refined by machine learning system trainer 352 over time as populated form samples 354 expand to include additional forms populated by user 302. In this sense, the machine learning system 350 may be able to learn information such as a user's name and date of birth, for example, based on the text that the user has historically provided into a “name” field and “date of birth” field, respectively. The target data type models utilized by machine learning system 350 may be further enhanced and/or corroborated by user information 358, which may include information about a user's social network, social actions or activities, profession, a user's preferences, or a user's current location.

The machine learning system 350 may perform n-gram to text entry field mapping in a manner similar to that which has been described above in reference to FIGS. 1 and 2. In some implementations, the machine learning system 350 maps n-grams to text entry fields using a bipartite graph matching algorithm.

Through use of target data type models, the machine learning system 350 may be able to determine the degree to which a given n-gram, e.g., provided by n-gram generator 334 and included as part of a hypothesis variant, exhibits the grammatical and/or lexical characteristics of the target data type of a given text entry field. In some implementations, the degree to which a given n-gram exhibits the grammatical and/or lexical characteristics of the target data type of a given text entry field is determined when a given n-gram to text entry field pair of a given mapping is considered by computing device 322. In these implementations, one or more of the relevancy score for the pair and the mapping score may be determined based at least on the degree to which the given n-gram exhibits the grammatical and/or lexical characteristics of the target data type of the given text entry field, as determined based on the one or more target data type models maintained by machine learning system trainer 352.

The mapping score for each mapping considered may be generated by machine learning system 350 based on one or more levels of correspondence between the n-grams and the text entry fields to which each n-gram has been mapped, respectively. A relevancy score for a given n-gram to text entry field pair of a mapping, e.g., that the mapping score may be based upon, may be based at least on the target data type for the pair's text entry field as identified by machine learning system 350, confidence scores and/or rankings provided for the words from which the pair's n-gram was generated as indicated in a word lattice provided by automatic speech recognizer 332, relevancy scores for other n-grams of the hypothesis variant, an estimated data type of the n-gram determined based on the one or more target data type models maintained by machine learning system trainer 352, a level of correspondence between the position of the n-gram in an n-gram sequence of the hypothesis variant and the position of the text entry field within the digital form, information retrieved from one or more search domains, populated form samples 354, labeled form samples 356, and user information 358. The machine learning system 350 may determine the mapping score based on the one or more relevancy scores determined for the one or more n-gram to text entry field pairs of the mapping, in a manner similar to that which has been described above in reference to FIGS. 1 and 2.

The machine learning system trainer 352 may further train the machine learning system 350 to learn a user's habits and leverage the knowledge of their habits to increase accuracy of its mapping score scheme. For instance, the machine learning system 350 may be learn, based on populated form samples 354 completed by user 302 and user information 358, that when the user's location included in user information 358 indicates that user 302 is located in Hawaii, the user 302 typically provides “8000 Volcano Beach Road, Honolulu, Hi.” to “address” fields of forms. In this example, if machine learning system 350 were to determine that user 302 is located in Hawaii while filling out the digital form, mapping scores for n-grams indicating a Hawaiian address may be favorably influenced, and vice versa.

In another example, the machine learning system 350 may learn that user 302 almost always skips text entry fields of forms that are optional. In this example, the machine learning system 350 may be trained to identify this feature of a text entry field based on information provided by parser 342 and labeled form samples 356. For this reason, the mapping scores generated by machine learning system 350 for mappings that exclude the population of optional fields may be favorably influenced.

Once machine learning system 350 has considered each mapping and generated mapping scores accordingly, an optimizer 360 may evaluate the output of the machine learning system 350 to select a mapping. In some implementations, the optimizer 360 performs mapping functions in place of or in addition to those performed by machine learning system 350. In some implementations, the mapping with the greatest mapping score is selected. Upon mapping selection, the optimizer will provide an updated digital form 364 to user device 306 that reflects the selected mapping. As described above, the digital form may be updated by computing device 322 continuously and in real-time.

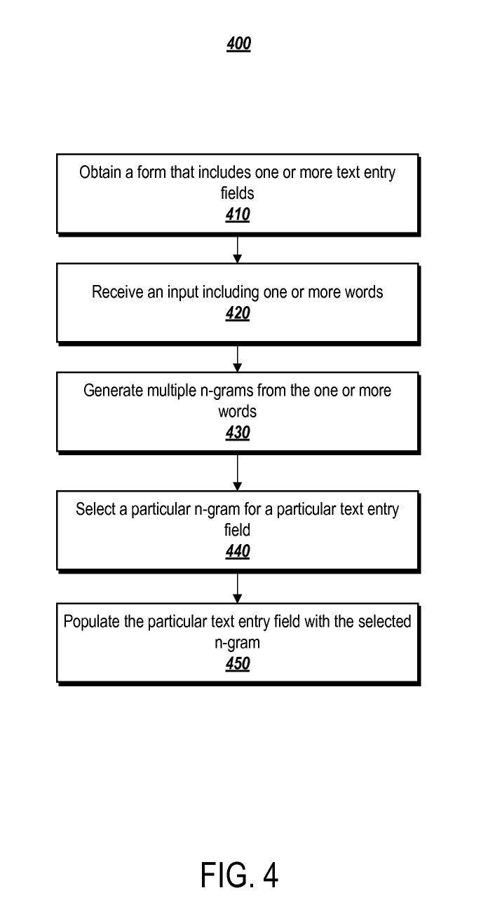

FIG. 4 is a flowchart of an example process 400 for mapping user input to fields of a form and populating the fields of the form with the appropriate information. The following describes the process 400 as being performed by components of systems that are described with reference to FIGS. 1-3. However, the process 400 may be performed by other systems or system configurations.

At 410, the process 400 may include obtaining a form that includes one or more text entry fields. For example, user device 106 and/or computing device 122 may obtain a form 108 that the user has accessed.

At 420, the process may include receiving an input including one or more words. In some examples, the process may include receiving an input including two or more words. For example, the input including one or more words may be one or more hypotheses provided by a word lattice generated for an utterance, e.g., the word lattice itself and/or an individual hypothesis provided by the word lattice. In some implementations, the input including one or more words may be a string of text provided by a user through use of a keyboard, for example. In these implementations, a user may use a keyboard to type a series of characters: “bobjones1/8/1960.” A computing device may handle this series of characters in a manner similar to the handling of transcription hypotheses described above.

At 430, the process may include generating multiple n-grams from the one or more words. For example, this may be performed by n-gram generator 334 when generating one or more hypothesis variants that each include one or more n-grams. As described above, the n-grams of the hypothesis variants are generated from words included in the original hypothesis. In implementations where the one or more words are a series of characters that the user has typed in, multiple variants of the series of characters that each include one or more n-grams may be generated. In these implementations, the n-grams included in each variant may be generated in a manner similar to that which has been described above. For example, a variant of “bobjones1/8/1960” might include a first n-gram, “Bob Jones,” and a second n-gram, “1/8/1960.” In the exemplary variant for the series of characters typed in by the user, it can be seen that the first n-gram, “Bob Jones,” is a phrase/collection of segments of the series of characters.

At 440, the process may include selecting a particular n-gram for a particular text entry field. For example, this may be performed in the evaluating mapping results and selecting a mapping that corresponds to mapping one or more particular n-grams to one or more text entry fields, respectively. In some implementations, this may be performed by a machine learning system, such as that which has been described above in reference to FIGS. 1-3, that may develop and update a mapping scoring scheme and determine mapping scores for each mapping considered. Mapping selections may be determined based at least on the mapping scores generated.

At 450, the process may include populating the particular text entry field with the selected n-gram. For instance, this may be performed by computing device 122 or 322 in populating the form according to the mapping selected. This may be performed in real-time or once it has been determined that the user has finished providing input for the form. Forms 108A-F depict a form 108 as populated with according to a mapping determined for various stages A-F.

In some implementations, the form may be updated in concurrence with or immediately following obtaining or receiving information to associate text entry fields with transcription portions. Such information may include one or more of information that indicates one or more mapping determination results, instructions that indicate how the form 108 is to be populated, an update for the form, and an updated version of the form. In some implementations, processes of associating text entry fields with transcription portions may still be executed in real-time as information to associate text entry fields with transcription portions is processed. In some examples, the form 108 may be periodically updated. In these examples, user device 106 may periodically update form 108 according to current associations between text entry fields and transcription portions. That is, the associations between text entry fields and transcription portions resulting from such associating processes may, in some implementations, be apparent in the form 108 as displayed. In some examples, processes of associating text entry fields with transcription portions may also be executed periodically.

In some implementations, the form may be updated once it has been determined that the user has finished providing input. For example, the system described herein may determine that a predetermined amount of time has elapsed since user input has been received and subsequently update the form. In some examples, the form may be update to detection of an event. Such events may include receipt of an incoming communication at the user device, expiration of one or more timers, and occurrence of one or more characteristics of user input, such as receipt of a user-initiated command.

In some implementations, a user may be provided with one or more opportunities to confirm and/or correct a populated form. For instance, the user may be presented with an interface that may allow the user to indicate that they would like to begin providing input for populating the form, indicate that the form has been populated erroneously, confirm a current state of the form, and indicate that they have finished providing input for populating the form. In some implementations, this feedback may be utilized to train the machine learning system.

Further, the interface may also allow the user to provide one or more commands. For example, the user might say “Please fill the form with the following values: use ‘Hans Mueller’ as the full name and enter the date of birth as ‘Feb. 29, 1989’” to provide mapping instructions. In these implementations, the computing system may recognize the user's commands and select a mapping with “Hans Mueller” corresponding to a name field and “Feb. 29, 1989” corresponding to a date of birth field. In some implementations, commands provided by the user and recognized by the computing device may be utilized to modify the mapping scoring scheme.

In some implementations, the computing device may modify one or more generated n-grams. This may include replacing information included in the n-gram or augmenting such an n-gram with additional information. In some implementations, such modifications are performed following selection of the mapping. In some implementations, such modifications are performed during n-gram generation by generating additional hypothesis variants including modified n-grams. In either case, n-gram modifications may be influenced by machine learning techniques and associated with a mapping score determined for their mapping.

In some implementations, the mapping performed in any of the methods and systems of FIGS. 1-4 is an injective and non-surjective mapping of n-grams of each variant of one or more words. In some implementations, the mapping performed in any of the methods and systems of FIGS. 1-4 is a non-injective and non-surjective mapping of one or more words. In these implementations, various non-injective and non-surjective mappings of the one or more words to a form may be considered. For instance, the one or more words may belong to a transcription hypothesis. One or more optimization processes, such as bipartite graph matching, graph cut, and Hungarian algorithms, may be utilized in selecting a particular non-injective and non-surjective mapping. In these implementations, communications between a user device and computing device may be performed in a manner similar to that which has been described above.

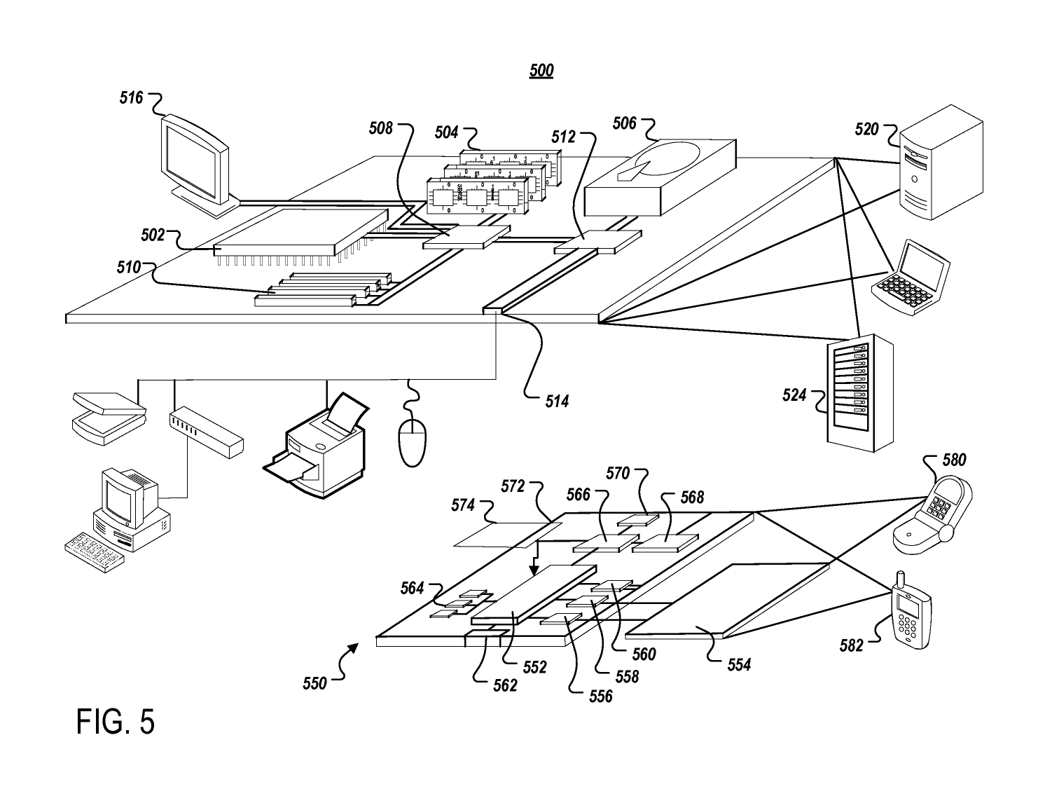

FIG. 5 shows an example of a computing device 500 and a mobile computing device 550 that can be used to implement the techniques described here. The computing device 500 is intended to represent various forms of digital computers, such as laptops, desktops, workstations, personal digital assistants, servers, blade servers, mainframes, and other appropriate computers. The mobile computing device 550 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 500 includes a processor 502, a memory 504, a storage device 506, a high-speed interface 508 connecting to the memory 504 and multiple high-speed expansion ports 510, and a low-speed interface 512 connecting to a low-speed expansion port 514 and the storage device 506. Each of the processor 502, the memory 504, the storage device 506, the high-speed interface 508, the high-speed expansion ports 510, and the low-speed interface 512, are interconnected using various busses, and may be mounted on a common motherboard or in other manners as appropriate. The processor 502 can process instructions for execution within the computing device 500, including instructions stored in the memory 504 or on the storage device 506 to display graphical information for a graphical user interface (GUI) on an external input/output device, such as a display 516 coupled to the high-speed interface 508. In other implementations, multiple processors and/or multiple buses may be used, as appropriate, along with multiple memories and types of memory. Also, multiple computing devices may be connected, with each device providing portions of the necessary operations, e.g., as a server bank, a group of blade servers, or a multi-processor system.

The memory 504 stores information within the computing device 500. In some implementations, the memory 504 is a volatile memory unit or units. In some implementations, the memory 504 is a non-volatile memory unit or units. The memory 504 may also be another form of computer-readable medium, such as a magnetic or optical disk.

The storage device 506 is capable of providing mass storage for the computing device 500. In some implementations, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices, for example, processor 502, perform one or more methods, such as those described above. The instructions can also be stored by one or more storage devices such as computer- or machine-readable mediums, for example, the memory 504, the storage device 506, or memory on the processor 502.

The high-speed interface 508 manages bandwidth-intensive operations for the computing device 500, while the low-speed interface 512 manages lower bandwidth-intensive operations. Such allocation of functions is an example only. In some implementations, the high-speed interface 508 is coupled to the memory 504, the display 516, e.g., through a graphics processor or accelerator, and to the high-speed expansion ports 510, which may accept various expansion cards (not shown). In the implementation, the low-speed interface 512 is coupled to the storage device 506 and the low-speed expansion port 514. The low-speed expansion port 514, which may include various communication ports, e.g., USB, Bluetooth, Ethernet, wireless Ethernet, may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. In addition, it may be implemented in a personal computer such as a laptop computer 522. It may also be implemented as part of a rack server system 524. Alternatively, components from the computing device 500 may be combined with other components in a mobile device (not shown), such as a mobile computing device 550. Each of such devices may contain one or more of the computing device 500 and the mobile computing device 550, and an entire system may be made up of multiple computing devices communicating with each other.

The mobile computing device 550 includes a processor 552, a memory 564, an input/output device such as a display 554, a communication interface 566, and a transceiver 568, among other components. The mobile computing device 550 may also be provided with a storage device, such as a micro-drive or other device, to provide additional storage. Each of the processor 552, the memory 564, the display 554, the communication interface 566, and the transceiver 568, are interconnected using various buses, and several of the components may be mounted on a common motherboard or in other manners as appropriate.

The processor 552 can execute instructions within the mobile computing device 550, including instructions stored in the memory 564. The processor 552 may be implemented as a chipset of chips that include separate and multiple analog and digital processors. The processor 552 may provide, for example, for coordination of the other components of the mobile computing device 550, such as control of user interfaces, applications run by the mobile computing device 550, and wireless communication by the mobile computing device 550.

The processor 552 may communicate with a user through a control interface 558 and a display interface 556 coupled to the display 554. The display 554 may be, for example, a TFT (Thin-Film-Transistor Liquid Crystal Display) display or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may provide communication with the processor 552, so as to enable near area communication of the mobile computing device 550 with other devices. The external interface 562 may provide, for example, for wired communication in some implementations, or for wireless communication in other implementations, and multiple interfaces may also be used.

The memory 564 stores information within the mobile computing device 550. The memory 564 can be implemented as one or more of a computer-readable medium or media, a volatile memory unit or units, or a non-volatile memory unit or units. An expansion memory 574 may also be provided and connected to the mobile computing device 550 through an expansion interface 572, which may include, for example, a SIMM (Single In Line Memory Module) card interface. The expansion memory 574 may provide extra storage space for the mobile computing device 550, or may also store applications or other information for the mobile computing device 550. Specifically, the expansion memory 574 may include instructions to carry out or supplement the processes described above, and may include secure information also. Thus, for example, the expansion memory 574 may be provided as a security module for the mobile computing device 550, and may be programmed with instructions that permit secure use of the mobile computing device 550. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier that the instructions, when executed by one or more processing devices, for example, processor 552, perform one or more methods, such as those described above. The instructions can also be stored by one or more storage devices, such as one or more computer- or machine-readable mediums, for example, the memory 564, the expansion memory 574, or memory on the processor 552. In some implementations, the instructions can be received in a propagated signal, for example, over the transceiver 568 or the external interface 562.

The mobile computing device 550 may communicate wirelessly through the communication interface 566, which may include digital signal processing circuitry where necessary. The communication interface 566 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 568 using a radio-frequency. In addition, short-range communication may occur, such as using a Bluetooth, WiFi, or other such transceiver (not shown). In addition, a GPS (Global Positioning System) receiver module 570 may provide additional navigation- and location-related wireless data to the mobile computing device 550, which may be used as appropriate by applications running on the mobile computing device 550.

The mobile computing device 550 may also communicate audibly using an audio codec 560, which may receive spoken information from a user and convert it to usable digital information. The audio codec 560 may likewise generate audible sound for a user, such as through a speaker, e.g., in a handset of the mobile computing device 550. Such sound may include sound from voice telephone calls, may include recorded sound, e.g., voice messages, music files, etc., and may also include sound generated by applications operating on the mobile computing device 550.

The mobile computing device 550 may be implemented in a number of different forms, as shown in the figure. For example, it may be implemented as a cellular telephone 580. It may also be implemented as part of a smart-phone 582, personal digital assistant, or other similar mobile device.

Embodiments of the subject matter, the functional operations and the processes described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps may be provided, or steps may be eliminated, from the described processes. Accordingly, other implementations are within the scope of the following claims.

1-5. (canceled)

6. A computer-implemented method comprising:
obtaining a form on a user device, where the form includes one or more text entry fields, wherein each text entry field is associated with a respective target data type;
receiving an input including one or more words;
generating multiple n-grams from the one or more words;
determining, based at least on the target data type associated with a particular text entry field of the one or more text entry fields included in the form, a mapping score that indicates a degree of confidence that the particular text entry field associated with the target data type is to be populated with a particular n-gram;
selecting, from among the multiple n-grams generated from the one or more words, a particular n-gram for a particular text entry field based at least on the mapping score that indicates the degree of confidence that the particular text entry field associated with the target data type is to be populated with the particular n-gram; and
populating the particular text entry field included in the form on the user device with the particular n-gram.

7. The computer-implemented method of claim 6, wherein determining, based at least on the target data type associated with a particular text entry field of the one or more text entry fields included in the form, a mapping score that indicates a degree of confidence that the particular text entry field associated with the target data type is to be populated with a particular n-gram comprises:
determining, based at least on the target data type associated with the particular text entry field, a mapping score that indicates a degree of confidence that (i) the particular text entry field and (ii) one or more of the text entry fields that are different from the particular text entry field, are to be populated with (I) the particular n-gram and (II) one or more of the multiple n-grams that are different from the particular n-gram, respectively.

8. The computer-implemented method of claim 7 comprising:
selecting, from among the multiple n-grams generated from the one or more words, one of the n-grams that is different from the particular n-gram for one of the text entry fields that is different from the particular text entry field, based at least on the mapping score; and
populating the text entry field that is different from the particular text entry field with the n-gram that is different from the particular n-gram.

9. The computer-implemented method of claim 6 comprising:
receiving user input that represents data provided by a user for populating the form; and
determining one or more transcription hypotheses for the user input, the one or more transcription hypotheses including one or more words, wherein receiving the input including one or more words comprises receiving the one or more transcription hypotheses.

10. The computer-implemented method of claim 9, wherein generating multiple n-grams from the one or more words comprises generating one or more n-grams from each of the one or more transcription hypotheses.

11. The computer-implemented method of claim 10, wherein receiving user input that represents data provided by a user for populating the form comprises receiving data that reflects an utterance of one or more words spoken by the user, and wherein determining one or more transcription hypotheses for the user input, the one or more transcription hypotheses including one or more words comprises determining one or more transcription hypotheses for the one or more words spoken by the user.

12. The computer-implemented method of claim 11 comprising:
determining one or more confidence scores for each of one or more of the transcription hypotheses that each indicate a degree of confidence in one or more words of the respective transcription hypothesis correctly representing one or more of the words spoken by the user, and wherein selecting, from among the multiple n-grams generated from the one or more words, the particular n-gram for the particular text entry field based at least on the mapping score that indicates the degree of confidence that the particular text entry field associated with the target data type is to be populated with the particular n-gram, comprises selecting, from among the multiple n-grams generated from the one or more words, the particular n-gram for the particular text entry field based at least on the mapping score that indicates the degree of confidence that the particular text entry field associated with the target data type is to be populated with the particular n-gram and one or more confidence scores associated with a particular transcription hypothesis from which the particular n-gram was generated.

13. The computer-implemented method of claim 6 comprising:
determining the respective target data types associated with text entry fields of the form; and
accessing, based on the respective target data types associated with text entry fields of the form, one or more target data type models that indicate one or more of grammatical and lexical characteristics associated with words of the respective target data types, and wherein selecting, from among the multiple n-grams generated from the one or more words, the particular n-gram for the particular text entry field based at least on the mapping score that indicates the degree of confidence that the particular text entry field associated with the target data type is to be populated with the particular n-gram, comprises selecting, from among the multiple n-grams generated from the one or more words, the particular n-gram for the particular text entry field based at least on (i) one or more of grammatical and lexical characteristics associated with words of the target data type associated with the particular text entry field, and (ii) one or more of grammatical and lexical characteristics associated with the particular n-gram.

14. The computer-implemented method of claim 13 wherein determining the respective target data types associated with text entry fields of the form, comprises determining the respective target data types associated with text entry fields of the form based at least on one or more labels included in the form that are associated with text entry fields of the form.

15. A system comprising:
one or more computers and one or more storage devices storing instructions that are operable, when executed by the one or more computers, to cause the one or more computers to perform operations comprising:
obtaining a form on a user device, where the form that includes one or more text entry fields, wherein each text entry field is associated with a respective target data type;
receiving an input including one or more words;
generating multiple n-grams from the one or more words;
determining, based at least on the target data type associated with a particular text entry field of the one or more text entry fields included in the form, a mapping score that indicates a degree of confidence that the particular text entry field associated with the target data type is to be populated with a particular n-gram;
selecting, from among the multiple n-grams generated from the one or more words, a particular n-gram for a particular text entry field based at least on the mapping score that indicates the degree of confidence that the particular text entry field associated with the target data type is to be populated with the particular n-gram; and
populating the particular text entry field included in the form on the user device with the particular n-gram.

16. The system of claim 15, wherein determining, based at least on the target data type associated with a particular text entry field of the one or more text entry fields included in the form, a mapping score that indicates a degree of confidence that the particular text entry field associated with the target data type is to be populated with a particular n-gram comprises:
determining, based at least on the target data type associated with the particular text entry field, a mapping score that indicates a degree of confidence that (i) the particular text entry field and (ii) one or more of the text entry fields that are different from the particular text entry field, are to be populated with (I) the particular n-gram and (II) one or more of the multiple n-grams that are different from the particular n-gram, respectively.

17. The system of claim 16, wherein the operations comprise:
selecting, from among the multiple n-grams generated from the one or more words, one of the n-grams that is different from the particular n-gram for one of the text entry fields that is different from the particular text entry field, based at least on the mapping score; and
populating the text entry field that is different from the particular text entry field with the n-gram that is different from the particular n-gram.

18. The system of claim 15, wherein the operations comprise:
receiving user input that represents data provided by a user for populating the form; and
determining one or more transcription hypotheses for the user input, the one or more transcription hypotheses including one or more words, wherein receiving the input including one or more words comprises receiving the one or more transcription hypotheses.

19. The system of claim 18, wherein generating multiple n-grams from the one or more words comprises generating one or more n-grams from each of the one or more transcription hypotheses.

20. The system of claim 19, wherein receiving user input that represents data provided by a user for populating the form comprises receiving data that reflects an utterance of one or more words spoken by the user, and wherein determining one or more transcription hypotheses for the user input, the one or more transcription hypotheses including one or more words comprises determining one or more transcription hypotheses for the one or more words spoken by the user.

21. The system of claim 20 comprising:
determining one or more confidence scores for each of one or more of the transcription hypotheses that each indicate a degree of confidence in one or more words of the respective transcription hypothesis correctly representing one or more of the words spoken by the user, and wherein selecting, from among the multiple n-grams generated from the one or more words, the particular n-gram for the particular text entry field based at least on the mapping score that indicates the degree of confidence that the particular text entry field associated with the target data type is to be populated with the particular n-gram, comprises selecting, from among the multiple n-grams generated from the one or more words, the particular n-gram for the particular text entry field based at least on the mapping score that indicates the degree of confidence that the particular text entry field associated with the target data type is to be populated with the particular n-gram and one or more confidence scores associated with a particular transcription hypothesis from which the particular n-gram was generated.

22. The system of claim 15 comprising:
determining the respective target data types associated with text entry fields of the form; and
accessing, based on the respective target data types associated with text entry fields of the form, one or more target data type models that indicate one or more of grammatical and lexical characteristics associated with words of the respective target data types, and wherein selecting, from among the multiple n-grams generated from the one or more words, the particular n-gram for the particular text entry field based at least on the mapping score that indicates the degree of confidence that the particular text entry field associated with the target data type is to be populated with the particular n-gram, comprises selecting, from among the multiple n-grams generated from the one or more words, the particular n-gram for the particular text entry field based at least on (i) one or more of grammatical and lexical characteristics associated with words of the target data type associated with the particular text entry field, and (ii) one or more of grammatical and lexical characteristics associated with the particular n-gram.

23. The system of claim 22, wherein determining the respective target data types associated with text entry fields of the form, comprises determining the respective target data types associated with text entry fields of the form based at least on one or more labels included in the form that are associated with text entry fields of the form.

24. A non-transitory computer-readable medium storing software comprising instructions executable by one or more computers which, upon such execution, cause the one or more computers to perform operations comprising:
obtaining a form on a user device, where the form includes one or more text entry fields, wherein each text entry field is associated with a respective target data type;
receiving an input including one or more words;
generating multiple n-grams from the one or more words;
determining, based at least on the target data type associated with a particular text entry field of the one or more text entry fields included in the form, a mapping score that indicates a degree of confidence that the particular text entry field associated with the target data type is to be populated with a particular n-gram;
selecting, from among the multiple n-grams generated from the one or more words, a particular n-gram for a particular text entry field based at least on the mapping score that indicates the degree of confidence that the particular text entry field associated with the target data type is to be populated with the particular n-gram; and
populating the particular text entry field included in the form on the user device with the particular n-gram.

25. The medium of claim 24, wherein determining, based at least on the target data type associated with a particular text entry field of the one or more text entry fields included in the form, a mapping score that indicates a degree of confidence that the particular text entry field associated with the target data type is to be populated with a particular n-gram comprises:
determining, based at least on the target data type associated with the particular text entry field, a mapping score that indicates a degree of confidence that (i) the particular text entry field and (ii) one or more of the text entry fields that are different from the particular text entry field, are to be populated with (I) the particular n-gram and (II) one or more of the multiple n-grams that are different from the particular n-gram, respectively.
